(19) United States
(12) Patent Application Publication
(10) Pub. No.: US 2026/0109632 A1
(43) Pub. Date: Apr. 23, 2026

(54) FACILITY AND METHOD FOR TREATING INDUSTRIAL AQUACULTURE TAIL WATER BY SEA CUCUMBERS AND ABALONES

(71) Applicant: Institute of Oceanology, Chinese Academy of Sciences, Qingdao (CN)

(72) Inventors: Chenggang Lin, Qingdao (CN); Jingchun Sun, Qingdao (CN); Lina Sun, Qingdao (CN); Huanxin Gao, Qingdao (CN); Shilin Liu, Qingdao (CN); Libin Zhang, Qingdao (CN); Hongsheng Yang, Qingdao (CN)

(73) Assignee: Institute of Oceanology, Chinese Academy of Sciences, Qingdao (CN)

(21) Appl. No.: 19/335,856

(22) Filed: Sep. 22, 2025

(30) Foreign Application Priority Data
Oct. 21, 2024 (CN) 202411463194.9

(51) Int. Cl. C02F 3/32; C02F 103/20

(52) U.S. Cl. CPC C02F 3/327; C02F 2103/20; C02F 2209/40

(57) ABSTRACT

The present disclosure provides a facility, including a water flow control device and an aquaculture device, where the water flow control device includes a sieve, a gate and a drain pipe, and the aquaculture device includes a longitudinal stepped aquaculture pond, a transverse stepped aquaculture pond, and tile adhesion bases. The longitudinal stepped aquaculture pond is provided with the sieve at a water inlet end and the drain pipe at a water outlet end. The transverse stepped aquaculture pond is provided on a side of the longitudinal stepped aquaculture pond, the gate is provided between a water inlet end of the transverse stepped aquaculture pond and the longitudinal stepped aquaculture pond, the transverse stepped aquaculture pond is provided with the drain pipe at a position away from the gate, and the tile adhesion bases are provided on bottoms of both the longitudinal stepped aquaculture pond and the transverse stepped aquaculture pond.

### CROSS-REFERENCE TO RELATED APPLICATIONS

The present application is based on and claims priority from the Chinese patent application No. 202411463194.9 filed on Oct. 21, 2024, the entire disclosure of which is incorporated herein by reference.

### TECHNICAL FIELD

The present disclosure relates to the technical field of industrial aquaculture tail water treatment, and particularly relates to a facility and a method for treating industrial aquaculture tail water by sea cucumbers and abalones.

### BACKGROUND

Main pollutants of mariculture tail water include organic matters, phosphorus, ammonia nitrogen, nitrite, and the like. Traditional treatment methods for the aquaculture tail water include physical methods, chemical methods, and biological methods, where the biological methods are most widely applied to microbial treatment. However, unlike inland aquaculture, the mariculture tail water has relatively high salinity and low carbon-nitrogen ratio, and is not suitable for the microbial treatment applied in traditional wastewater treatment. Therefore, the microbial treatment effect is not ideal in the treatment of mariculture tail water. The newly proposed seawater recirculating aquaculture system can purify and recycle the aquaculture tail water for repeated use, which not only reduces the pollution to coastal water, but also facilitates improvement of the yield and accelerates the growth speed of the cultured organisms. However, workshop reconstruction is costly and the maintenance is difficult. Selecting a proper treatment mode of the aquaculture tail water to realize full utilization of the aquaculture tail water has become an inevitable trend of future development.

Sea cucumbers and abalones are important mariculture species in China, and have high nutritional and economic values. Researches show that the aquaculture of sea cucumbers and abalones can not only reduce nitrogen, total organic carbon, particulate organic matters and transparent exopolymer particles (TEP) in the aquaculture pond, but also consume organic substances in sediments, as well as fish excrement, excessive fish food, algae, and the like. By throwing sea cucumbers and abalones into a seawater environment with a relatively high nutrition load, waste particulate matters from organisms of different nutrition levels can be utilized, and the sea cucumbers and the abalones can extract particulate waste from the aquaculture tail water and convert them into valuable biomass in the process, which can reduce the potential influence of aquaculture activities on the environment and increase the utilization efficiency of energy, and thereby can be used as an effective means for treating industrial aquaculture tail water.

### SUMMARY

The present disclosure provides a facility and a method for treating industrial aquaculture tail water by sea cucumbers and abalones, which can use tail water discharged from industrial aquaculture every day as aquaculture water for sea cucumbers and abalones by means of stepped aquaculture ponds and other ancillary facilities.

The facility provided in the embodiments of the present disclosure includes a water flow control device and an aquaculture device, where the water flow control device includes a sieve, a gate and a drain pipe, and the aquaculture device includes a longitudinal stepped aquaculture pond, a transverse stepped aquaculture pond, and tile adhesion bases, a length direction of the longitudinal stepped aquaculture pond is a flowing direction of the aquaculture tail water, in the length direction, the longitudinal stepped aquaculture pond is provided with the sieve at a water inlet end and the drain pipe at a water outlet end, and the transverse stepped aquaculture pond is provided on a side of the length direction of the longitudinal stepped aquaculture pond, the gate is provided between a water inlet end of the transverse stepped aquaculture pond and the longitudinal stepped aquaculture pond, the transverse stepped aquaculture pond is provided with the drain pipe at a position away from the gate, a length direction of the transverse stepped aquaculture pond is perpendicular to the length direction of the longitudinal stepped aquaculture pond, and the aquaculture tail water entering the transverse stepped aquaculture pond via the gate flows in an S-shaped mode; and the tile adhesion bases are provided on bottoms of both the longitudinal stepped aquaculture pond and the transverse stepped aquaculture pond.

The longitudinal stepped aquaculture pond is divided into a plurality of stepped aquaculture ponds arranged in the length direction thereof, and the aquaculture tail water entering via the sieve sequentially flows through the aquaculture ponds by gravity.

In the length direction of the longitudinal stepped aquaculture pond, each aquaculture pond has a bottom having a center lower than both sides, and a drain port with the drain pipe having an adjustable height is installed in the bottom of the lowest aquaculture pond.

A water conduit is provided at a bottom of a pond wall between two adjacent aquaculture ponds of the longitudinal stepped aquaculture pond, wherein the water conduit is L-shaped, a vertical part of the L-shaped conduit is a water inlet side at an adjustable angle to the bottom of the aquaculture pond, and a horizontal part of the L-shaped conduit is a water outlet side in communication with a next neighboring aquaculture pond.

The transverse stepped aquaculture pond is divided into a plurality of stepped aquaculture ponds arranged in a width direction thereof, and the aquaculture tail water entering via the gate sequentially flows through the aquaculture ponds by gravity.

In the length direction of the transverse stepped aquaculture pond, each aquaculture pond has a bottom having a center lower than both sides, and a drain port with the drain pipe having an adjustable height is installed in the bottom of each aquaculture pond at an end away from the longitudinal stepped aquaculture pond.

A water conduit is provided on a pond wall between two adjacent aquaculture ponds of the transverse stepped aquaculture pond, wherein water conduits on adjacent two pond walls are respectively positioned at two ends of the transverse stepped aquaculture pond in the width direction, so that the aquaculture tail water flows in an S-shaped mode in the transverse stepped aquaculture pond; and the water conduit is L-shaped, a vertical part of the L-shaped conduit is a water inlet side at an adjustable angle to the bottom of the aquaculture pond, and a horizontal part of the L-shaped conduit is a water outlet side in communication with a next neighboring aquaculture pond.

The facility further includes an oxygenation device including an air pump, an air pipe A, an air valve, and an air pipe B, the transverse stepped aquaculture pond is divided into a plurality of stepped aquaculture ponds arranged in a width direction thereof, a plurality of air pipes B are laid along the length direction in each aquaculture pond of the transverse stepped aquaculture pond, each air pipe B is connected to the air pipe A and provided with the air valve at a joint of the two, and the air pump is connected to the air pipe A.

On a pond wall of the transverse stepped aquaculture pond, or on pond walls of the longitudinal stepped aquaculture pond and the transverse stepped aquaculture pond, an awning for shielding light, rain and wind is provided.

The method for treating industrial aquaculture tail water by sea cucumbers and abalones provided in the present disclosure includes: using tail water discharged from industrial aquaculture every day as aquaculture water for the sea cucumbers and the abalones, and reasonably arranging numbers of ponds of the longitudinal stepped aquaculture pond and the transverse stepped aquaculture pond in use according to a discharge amount of the aquaculture tail water; allowing the industrial aquaculture tail water to enter the longitudinal stepped aquaculture pond through the sieve, opening or closing the gate according to an output amount of the aquaculture tail water, distributing the aquaculture tail water into the transverse stepped aquaculture pond, uniformly placing the tile adhesion bases in the longitudinal stepped aquaculture pond and the transverse stepped aquaculture pond, controlling, after the sea cucumbers and the abalones are thrown in, volumes of the aquaculture tail water in the longitudinal stepped aquaculture pond and the transverse stepped aquaculture pond by adjusting an angle and a height of the drain pipe, inflating the transverse stepped aquaculture pond and using an awning to shield light, so that illuminations and temperatures in the longitudinal stepped aquaculture pond and the transverse stepped aquaculture pond are guaranteed; and precipitating so that organic suspended particles in the aquaculture tail water are precipitated onto the tile adhesion bases and bottoms of the longitudinal stepped aquaculture pond and the transverse stepped aquaculture pond to feed the sea cucumbers and the abalones.

### BRIEF DESCRIPTION OF DRAWINGS

FIG. 1 is a first schematic perspective view of a facility according to an embodiment of the present disclosure;

FIG. 2 is a second schematic perspective view of a facility according to an embodiment of the present disclosure;

FIG. 3 is a first physical image of a facility at a test site according to an embodiment of the present disclosure;

FIG. 4 is a second physical image of a facility at a test site according to an embodiment of the present disclosure; and

FIG. 5 is a third physical image of a facility at a test site according to an embodiment of the present disclosure;

in which: 1. sieve, 2. gate, 3. water conduit, 4. drain pipe, 5. air pump, 6. air pipe A, 7. air valve, 8. longitudinal stepped aquaculture pond, 9. transverse stepped aquaculture pond, 10. tile adhesion base, 11. awning, and 12. air pipe B.

### DETAIL DESCRIPTION OF EMBODIMENTS

To treat industrial aquaculture tail water and utilize wastes such as residual baits, excrement and the like in the aquaculture tail water, the present disclosure provides a facility and a method for treating industrial aquaculture tail water by sea cucumbers and abalones, which can use tail water discharged from industrial aquaculture every day as aquaculture water for sea cucumbers and abalones by means of stepped aquaculture ponds and other ancillary facilities, and reasonably arrange numbers of aquaculture ponds in use according to a discharge amount of the aquaculture tail water, thereby enabling the advantages of reducing bait input, alleviating tail water pollution and improving economic benefits.

The present disclosure will be further explained in detail below in conjunction with the accompanying drawings.

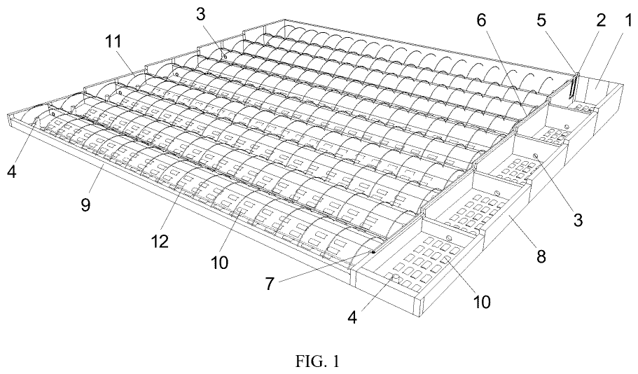

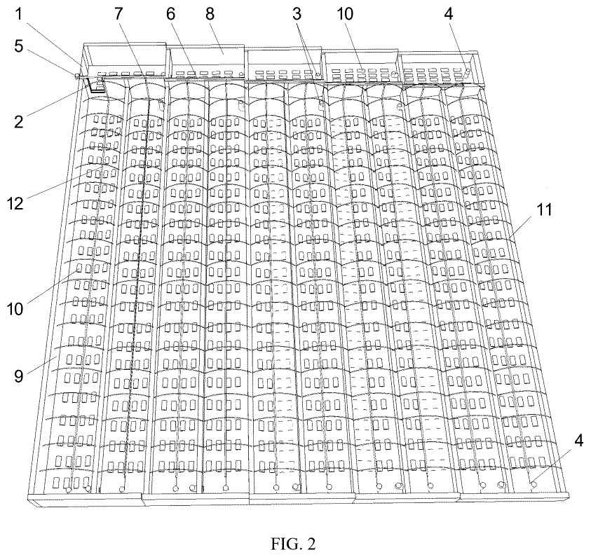

As shown in FIGS. 1 and 2, the present disclosure provides a facility including a water flow control device and an aquaculture device. The water flow control device includes a sieve 1, a gate 2 and a drain pipe 4, and the aquaculture device includes a longitudinal stepped aquaculture pond 8, a transverse stepped aquaculture pond 9, and tile adhesion bases 10. A length direction of the longitudinal stepped aquaculture pond 8 is a flowing direction of the aquaculture tail water. In the length direction, the longitudinal stepped aquaculture pond 8 is provided with the sieve 1 at a water inlet end and the drain pipe 4 at a water outlet end. The transverse stepped aquaculture pond 9 is provided on a side of the length direction of the longitudinal stepped aquaculture pond 8. The gate 2 is provided between a water inlet end of the transverse stepped aquaculture pond 9 and the longitudinal stepped aquaculture pond 8. The transverse stepped aquaculture pond 9 is provided with the drain pipe 4 at a position away from the gate 2. A length direction of the transverse stepped aquaculture pond 9 is perpendicular to the length direction of the longitudinal stepped aquaculture pond 8. The aquaculture tail water entering the transverse stepped aquaculture pond 9 via the gate 2 flows in an S-shaped mode. The tile adhesion bases 10 are provided on bottoms of both the longitudinal stepped aquaculture pond 8 and the transverse stepped aquaculture pond 9.

In the embodiment, Stichopus japonicus, Haliotis discus hannai and other high-value deposit feeder aquaculture species are selected as aquaculture objects to guarantee the treatment effect and economic benefit of the aquaculture tail water.

In this embodiment, the longitudinal stepped aquaculture pond 8 is divided into a plurality of stepped aquaculture ponds arranged in the length direction thereof with a slope greater than 5°, which can ensure that the aquaculture tail water entering via the sieve 1 (i.e., the uppermost aquaculture tail water) sequentially flows through the aquaculture ponds by gravity. In this embodiment, each aquaculture pond of the longitudinal stepped aquaculture pond 8 has a rectangular shape with a length of 400 cm, a width of 200 cm, and a depth of 100 cm, and with a bottom having a center lower than both sides in the length direction. In other words, the bottom of each aquaculture pond is V-shaped, with a center lower than both sides by 3 cm to 5 cm. A drain port, which is 10 cm away from a lower pond wall of the lowest aquaculture pond of the longitudinal stepped aquaculture pond 8, is provided in the bottom of the lowest aquaculture pond, and provided with the drain pipe 4, where the drain pipe 4 has a height selectable according to a water level, thereby obtaining a height-adjustable drain pipe 4. In this embodiment, two adjacent aquaculture ponds of the longitudinal stepped aquaculture pond 8 share one pond wall, which means that a lower pond wall of an upper aquaculture pond also serves as an upper pond wall of a next aquaculture pond, and a water conduit 3 is provided at a bottom of the shared pond wall. In this embodiment, the water conduit 3 is an L-shaped conduit made of polyvinyl chloride (PVC), where a vertical part of the L-shaped conduit is a water inlet side (with a height of 90 cm) at an adjustable angle to the bottom of the aquaculture pond to adjust a water level in the aquaculture pond, and a horizontal part of the L-shaped conduit is a water outlet side (with a length of 15 cm) in communication with a next neighboring aquaculture pond.

In this embodiment, the transverse stepped aquaculture pond 9 is divided into a plurality of stepped aquaculture ponds arranged in a width direction thereof with a slope greater than 5°, which can ensure that the aquaculture tail water entering via the gate 2 (i.e., the uppermost aquaculture tail water) sequentially flows through the aquaculture ponds by gravity. A width direction of the transverse stepped aquaculture pond 9 is consistent with the length direction of the longitudinal stepped aquaculture pond 8. In this embodiment, each aquaculture pond of the transverse stepped aquaculture pond 9 has a rectangular shape with a length of 2000 cm, a width of 200 cm, and a depth of 100 cm, and with a bottom having a center lower than both sides in the length direction. In other words, the bottom of each aquaculture pond is V-shaped, with a center lower than both sides by 3 cm to 5 cm. The gate 2 is provided at an end in the length direction of the highest aquaculture pond of the transverse stepped aquaculture pond 9. When a quantity of the industrial aquaculture tail water exceeds a capacity of the longitudinal stepped aquaculture pond 8, the gate 2 is opened to shunt the aquaculture tail water into the transverse stepped aquaculture pond 9. A drain port, 10 cm away from a pond wall in the width direction, is installed in the bottom of each aquaculture pond at an end (i.e., another end opposite to the gate) away from the longitudinal stepped aquaculture pond 8, and provided with the drain pipe 4, where the drain pipe 4 has a height selectable according to a water level, thereby obtaining a height-adjustable drain pipe 4. In this embodiment, two adjacent aquaculture ponds of the transverse stepped aquaculture pond 9 share one pond wall, which means that a lower pond wall of an upper aquaculture pond in the length direction also serves as an upper pond wall of a next aquaculture pond in the length direction, and a water conduit 3 is provided on the shared pond wall. Water conduits 3 on two adjacent shared pond walls are respectively positioned at two ends of the transverse stepped aquaculture pond 9 in the width direction, so that the aquaculture tail water flows in an S-shaped mode in the transverse stepped aquaculture pond 9. In this embodiment, the water conduit 3 is an L-shaped conduit made of polyvinyl chloride (PVC), where a vertical part of the L-shaped conduit is a water inlet side (with a height of 90 cm) at an adjustable angle to the bottom of the aquaculture pond to adjust a water level in the aquaculture pond, and a horizontal part of the L-shaped conduit is a water outlet side (with a length of 15 cm) in communication with a next neighboring aquaculture pond.

Considering a longer water exchanging time of the transverse stepped aquaculture pond 9 in a transverse direction as well as a greater length of each aquaculture pond, the embodiment further includes an oxygenation device including an air pump 5, an air pipe A 6, an air valve 7, and an air pipe B 12. The air pipe A 6 is provided on a pond wall between the longitudinal stepped aquaculture pond 8 and the transverse stepped aquaculture pond 9, and the air pump 5 is connected to the air pipe A 6. A plurality of air pipes B 12 are laid along the length direction in each aquaculture pond of the transverse stepped aquaculture pond 9, and the air pipe B 12 is located at a center of the bottom of the aquaculture pond to ensure uniform and sufficient inflation. Each air pipe B 12 is connected to the air pipe A 6 and provided with the air valve 7 at a joint of the two. In other words, the air pipe A 6 is provided with air pipes B 12 connected in parallel, of the same number as and in one-to-one correspondence with aquaculture ponds in the transverse stepped aquaculture pond 9.

An awning 11 is provided on a pond wall of the transverse stepped aquaculture pond 9, or on pond walls of the longitudinal stepped aquaculture pond 8 and the transverse stepped aquaculture pond 9. In this embodiment, an awning support is provided on the pond wall of each aquaculture pond of the transverse stepped aquaculture pond 9, and then the awning 11 made of polyethylene is provided on the awning support to shield light, rain and wind.

The method for treating industrial aquaculture tail water by sea cucumbers and abalones provided in the present disclosure includes: using, by the facility for treating industrial aquaculture tail water by sea cucumbers and abalones described above, tail water discharged from industrial aquaculture every day as aquaculture water for Stichopus japonicus and Haliotis discus hannai, and reasonably arranging numbers of ponds of the longitudinal stepped aquaculture pond 8 and the transverse stepped aquaculture pond 9 in use according to a discharge amount of the aquaculture tail water; allowing the industrial aquaculture tail water to enter the longitudinal stepped aquaculture pond 8 through the sieve 1, opening or closing the gate 2 according to an output amount of the aquaculture tail water, distributing the aquaculture tail water into the transverse stepped aquaculture pond 9, filling the aquaculture tail water into the ponds of the longitudinal stepped aquaculture pond 8 and the transverse stepped aquaculture pond 9 by gravity and guided by the water conduit 3, uniformly placing the tile adhesion bases 10 in the longitudinal stepped aquaculture pond 8 and the transverse stepped aquaculture pond 9, controlling, after the Stichopus japonicus and the Haliotis discus hannai are thrown in, volumes of the aquaculture tail water in the longitudinal stepped aquaculture pond 8 and the transverse stepped aquaculture pond 9 by adjusting an angle and a height of the drain pipe 4. After precipitation, organic suspended particles in the aquaculture tail water are precipitated onto the tile adhesion bases 10 and bottoms of the ponds to feed the Stichopus japonicus and the Haliotis discus hannai, so that waste organic pollutants such as residual baits, excrement and the like in the industrial aquaculture tail water are treated by the cultured Stichopus japonicus and the Haliotis discus hannai, and suspended matters in the aquaculture tail water are effectively reduced. Then, the transverse stepped aquaculture pond 9 is inflated and the awning 11 is used to shield light, so that illuminations and temperatures in the longitudinal stepped aquaculture pond 8 and the transverse stepped aquaculture pond 9 are guaranteed, and the economic benefits are increased while the aquaculture tail water is treated, thereby reducing bait input and alleviating tail water pollution.

### Experimental Example

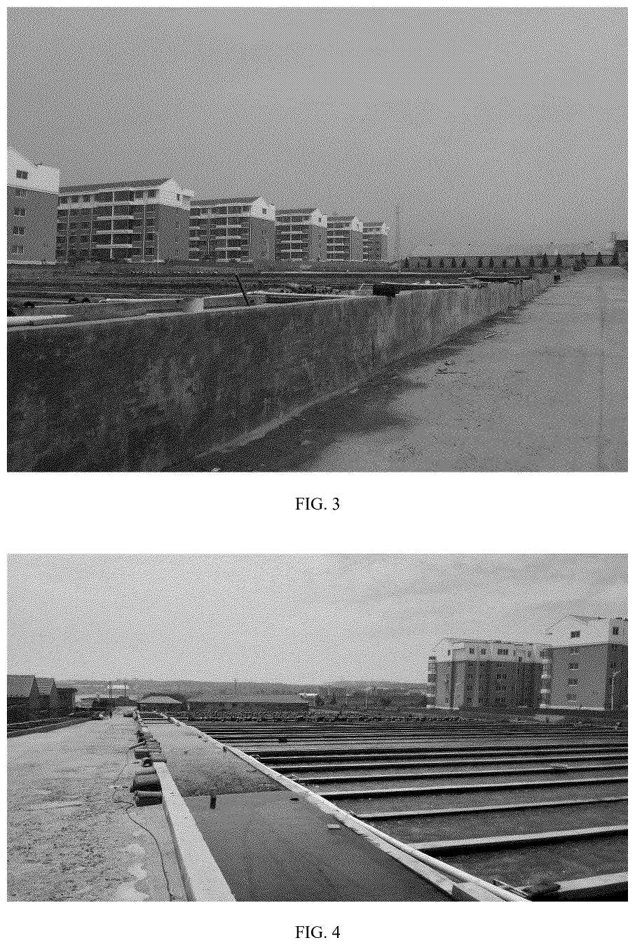

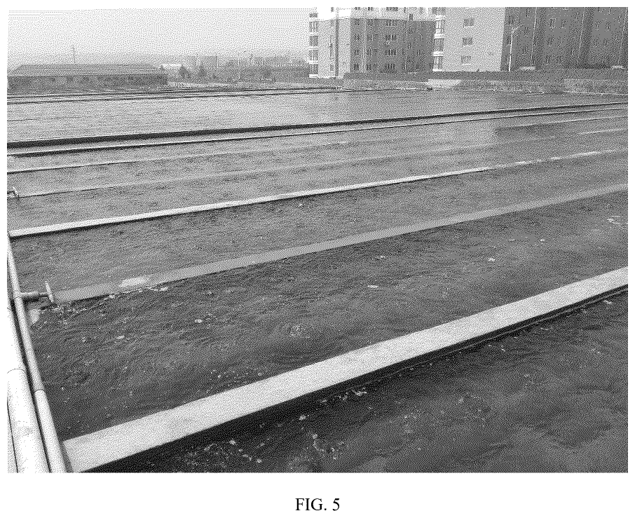

FIGS. 3 to 5 in the present disclosure are all physical images, which show a facility of the present disclosure built outside a farm for experiments conducted in an aquaculture company in Rongcheng, Weihai, Shandong province of China, where a concentration of suspended matters in the aquaculture water may be up to 45±5 mg/L. After being treated by the facility of the present disclosure, the suspended matters can be removed by more than 85%.

The present disclosure can enable a high removal efficiency of organic pollutants in the industrial aquaculture tail water and low operation cost, while the cultured Stichopus japonicus and Haliotis discus hannai have high economic values. Therefore, the present disclosure is suitable for treatment of the industrial aquaculture tail water.

The present disclosure has the following advantages and positive effects:
1. The aquaculture ponds arranged in a stepped mode in the present disclosure can enable water exchange solely by gravity, thereby saving power.
2. In the present disclosure, the aquaculture tail water is treated by culturing precious marine products such as Stichopus japonicus and Haliotis discus hannai, which can effectively utilize wastes such as residual baits, excrement and the like in the aquaculture tail water, and increase the economic benefits while the aquaculture tail water is treated.

The above are merely embodiments of the present disclosure and are not intended to limit the scope of the present disclosure. Any amendments, equivalent substitutions, improvements, extensions, and the like within the principle of the present disclosure are all included in the scope of the protection defined by the appended claims of the present disclosure.

What is claimed is:

1. A facility for treating industrial aquaculture tail water by sea cucumbers and abalones, characterized in that: the facility comprises a water flow control device and an aquaculture device, wherein the water flow control device comprises a sieve (1), a gate (2) and a drain pipe (4), and the aquaculture device comprises a longitudinal stepped aquaculture pond (8), a transverse stepped aquaculture pond (9), and tile adhesion bases (10),
a length direction of the longitudinal stepped aquaculture pond (8) is a flowing direction of the aquaculture tail water, in the length direction, the longitudinal stepped aquaculture pond (8) is provided with the sieve (1) at a water inlet end and the drain pipe (4) at a water outlet end, and the transverse stepped aquaculture pond (9) is provided on a side of the length direction of the longitudinal stepped aquaculture pond (8),
the gate (2) is provided between a water inlet end of the transverse stepped aquaculture pond (9) and the longitudinal stepped aquaculture pond (8), the transverse stepped aquaculture pond (9) is provided with the drain pipe (4) at a position away from the gate (2), a length direction of the transverse stepped aquaculture pond (9) is perpendicular to the length direction of the longitudinal stepped aquaculture pond (8), and the aquaculture tail water entering the transverse stepped aquaculture pond (9) via the gate (2) flows in an S-shaped mode; and
the tile adhesion bases (10) are provided on bottoms of both the longitudinal stepped aquaculture pond (8) and the transverse stepped aquaculture pond (9).

2. The facility for treating industrial aquaculture tail water by sea cucumbers and abalones according to claim 1, characterized in that: the longitudinal stepped aquaculture pond (8) is divided into a plurality of stepped aquaculture ponds arranged in the length direction thereof, and the aquaculture tail water entering via the sieve (1) sequentially flows through the aquaculture ponds by gravity.

3. The facility for treating industrial aquaculture tail water by sea cucumbers and abalones according to claim 2, characterized in that: in the length direction of the longitudinal stepped aquaculture pond (8), each aquaculture pond has a bottom having a center lower than both sides, and a drain port with the drain pipe (4) having an adjustable height is installed in the bottom of the lowest aquaculture pond.

4. The facility for treating industrial aquaculture tail water by sea cucumbers and abalones according to claim 2, characterized in that: a water conduit (3) is provided at a bottom of a pond wall between two adjacent aquaculture ponds of the longitudinal stepped aquaculture pond (8), wherein the water conduit (3) is L-shaped, a vertical part of the L-shaped conduit is a water inlet side at an adjustable angle to the bottom of the aquaculture pond, and a horizontal part of the L-shaped conduit is a water outlet side in communication with a next neighboring aquaculture pond.

5. The facility for treating industrial aquaculture tail water by sea cucumbers and abalones according to claim 1, characterized in that: the transverse stepped aquaculture pond (9) is divided into a plurality of stepped aquaculture ponds arranged in a width direction thereof, and the aquaculture tail water entering via the gate (2) sequentially flows through the aquaculture ponds by gravity.

6. The facility for treating industrial aquaculture tail water by sea cucumbers and abalones according to claim 5, characterized in that: in the length direction of the transverse stepped aquaculture pond (9), each aquaculture pond has a bottom having a center lower than both sides, and a drain port with the drain pipe (4) having an adjustable height is installed in the bottom of each aquaculture pond at an end away from the longitudinal stepped aquaculture pond (8).

7. The facility for treating industrial aquaculture tail water by sea cucumbers and abalones according to claim 5, characterized in that: a water conduit (3) is provided on a pond wall between two adjacent aquaculture ponds of the transverse stepped aquaculture pond (9), wherein water conduits (3) on two adjacent pond walls are respectively positioned at two ends of the transverse stepped aquaculture pond (9) in the width direction, so that the aquaculture tail water flows in an S-shaped mode in the transverse stepped aquaculture pond (9); and the water conduit (3) is L-shaped, a vertical part of the L-shaped conduit is a water inlet side at an adjustable angle to the bottom of the aquaculture pond, and a horizontal part of the L-shaped conduit is a water outlet side in communication with a next neighboring aquaculture pond.

8. The facility for treating industrial aquaculture tail water by sea cucumbers and abalones according to claim 1, characterized in that: the facility further comprises an oxygenation device comprising an air pump (5), an air pipe A (6), an air valve (7), and an air pipe B (12), the transverse stepped aquaculture pond (9) is divided into a plurality of stepped aquaculture ponds arranged in a width direction thereof, and a plurality of air pipes B (12) are laid along the length direction in each aquaculture pond of the transverse stepped aquaculture pond (9), each air pipe B (12) is connected to the air pipe A (6) and provided with the air valve (7) at a joint of the two, and the air pump (5) is connected to the air pipe A (6).

9. The facility for treating industrial aquaculture tail water by sea cucumbers and abalones according to claim 1, characterized in that: on a pond wall of the transverse stepped aquaculture pond (9), or on pond walls of the longitudinal stepped aquaculture pond (8) and the transverse stepped aquaculture pond (9), an awning (11) for shielding light, rain and wind is provided.

10. A method for treating industrial aquaculture tail water by sea cucumbers and abalones, characterized in comprising: using, by the facility for treating industrial aquaculture tail water by sea cucumbers and abalones according to claim 1, tail water discharged from industrial aquaculture every day as aquaculture water for the sea cucumbers and the abalones, and reasonably arranging numbers of ponds of the longitudinal stepped aquaculture pond (8) and the transverse stepped aquaculture pond (9) in use according to a discharge amount of the aquaculture tail water;
allowing the industrial aquaculture tail water to enter the longitudinal stepped aquaculture pond (8) through the sieve (1), opening or closing the gate (2) according to an output amount of the aquaculture tail water, distributing the aquaculture tail water into the transverse stepped aquaculture pond (9), uniformly placing the tile adhesion bases (10) in the longitudinal stepped aquaculture pond (8) and the transverse stepped aquaculture pond (9), controlling, after the sea cucumbers and the abalones are thrown in, volumes of the aquaculture tail water in the longitudinal stepped aquaculture pond (8) and the transverse stepped aquaculture pond (9) by adjusting an angle and a height of the drain pipe (4), inflating the transverse stepped aquaculture pond (9) and using an awning (11) to shield light, so that illuminations and temperatures in the longitudinal stepped aquaculture pond (8) and the transverse stepped aquaculture pond (9) are guaranteed; and precipitating so that organic suspended particles in the aquaculture tail water are precipitated onto the tile adhesion bases (10) and bottoms of the longitudinal stepped aquaculture pond (8) and the transverse stepped aquaculture pond (9) to feed the sea cucumbers and the abalones.
